(19) United States
(12) Patent Application Publication
(10) Pub. No.: US 2009/0098965 A1
(43) Pub. Date: Apr. 16, 2009

(54) TRACTION MECHANISM DRIVE FOR MACHINE PARTS AND DRIVE ASSEMBLIES

(75) Inventors: Bolko Schuseil, Adelsdorf (DE); Thomas Ullein, Frensdorf (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: SCHAEFFLER KG, Herzogenaurach (DE)

(21) Appl. No.: 12/298,310

(22) PCT Filed: Mar. 23, 2007
(86) PCT No.: PCT/EP2007/052805

§ 371 Date: Oct. 24, 2008

(30) Foreign Application Priority Data
Apr. 27, 2006 (DE) 102006019539.6

(51) Int. Cl. F16H 7/08

(52) U.S. Cl. 474/111

(57) ABSTRACT

The invention relates to a traction mechanism drive (1) for machine parts and drive assemblies, for example, in automotive engineering, with an endless traction element (2), wherein the traction element (2) is guided by driving and driven wheels (3, 4, 5), and with a tensioning rail (10) that can pivot about a point of rotation (13) on one end for contacting the traction element (2) and also with an actuator (11) acting on the tensioning rail (10). To prevent loss of preliminary tensioning of the traction or traction element (2), a mechanical free-wheel is integrated at the point of rotation (13) of the tensioning rail (10) at the one end as a reverse-rotation locking or limiting device.

### FIELD OF THE INVENTION

The invention relates to a traction mechanism drive for machine parts and drive assemblies, for example, in automotive engineering, with endless belt element, wherein the belt element is guided by driving and driven wheels, and with a tensioning rail that can pivot about a point of rotation at one end for contacting the belt element and also with an actuator acting on the tensioning rail.

### BACKGROUND

Such traction mechanism drives are known in various configurations. They are used for tensioning a belt, a chain, or the like for driving various auxiliary assemblies, e.g., on an engine block of a motor vehicle or other machine parts and drive assemblies. In a traction mechanism drive, the flexible, elastic traction or belt element transmits the tangential force as a traction force from a driving shaft to a driven shaft with a pure friction-fit connection, e.g., a flat, V-shaped, or V-ribbed belt, or with an additional positive-fit connection, e.g., a synchronous belt or toothed belt.

Especially in motor vehicles, belt or chain drives are used, in order to drive the camshafts of the internal combustion engine from the crankshaft in order to open and close the intake or exhaust valves of the engine. Other auxiliary assemblies, such as, for example, water pumps, fuel pumps, air-conditioning systems, etc., can also be driven by such belt or chain drives.

In traction mechanism drives, in order to be able to reliably transmit the necessary driving torque to the shafts to be driven, a sufficient biasing force in the traction mechanism drive must be guaranteed. Simultaneously, the number and arrangement of auxiliary assemblies to be driven in auxiliary assembly drives should be kept small or compact, in order to be able to largely avoid unnecessary disturbances, such as additional alternating bending of the traction mechanism due to deflection and tensioning rollers in the traction mechanism drive.

For example, from DE 10 2004 012 141 A1 a belt drive is known that has an integrated generator with a traction mechanism roller that is arranged on its generator shaft and on which the traction mechanism is guided. This belt drive is supported so that it can move against a restoring force for tensioning the traction mechanism. Here, the traction mechanism roller can be decoupled from the generator shaft for damping load spikes occurring on the drive side by means of a free-wheel. Accordingly, the traction mechanism roller is decoupled when a load spike appears and rotates freely with respect to the generator shaft, so that the load spike does not act fully on the traction mechanism drive. Here, the generator shaft is not actively braked, but its rotational speed decreases due to its internal friction.

Frequently, in internal combustion engines for motor vehicles, tensioning rails with hydraulic tensioning elements in the form of piston-cylinder units are used on chain-belt and toothed-belt drives. These tensioning elements must be able to both extend and also be compressed depending on function. The compressibility that is typically performed by pressing the hydraulic medium out of a high-pressure damping space via a leakage gap or a diaphragm always becomes a functional disadvantage when the loading is not performed dynamically over a short time, as in normal engine operation, but instead statically over a long time, for example, when the engine is at a standstill. In such a tensioning element, the hydraulic space is then, under some circumstances, completely emptied and the element is compressed greatly, especially for an elongated traction mechanism. Therefore, under certain operating conditions there can be the result that the traction mechanism loses its prior tensioning so much that problem-free functioning of the control of the drive is no longer guaranteed for inverted, that is, normal loading and it results in losses in function, such as, for example, tooth jumping.

From DE 199 56 536 A1 and DE 100 02 606 A1, a driving device with a traction mechanism drive is known in which a traction mechanism tensioning device has a force-storage element in the form of compression springs for delivering a force maintaining the traction mechanism tension. Furthermore, this comprises a ratcheting device with a locking or free-running device that locks in one direction and that can move in the opposite direction and that is constructed as a latch-like catch device and that permits tensioning or additional tensioning of the traction mechanism by tightening the traction mechanism in a tensioning direction, but locking in the opposite direction, especially via a tensioning roller.

Such catch-step or latch systems with an integrated mechanical drop securing device cannot always effectively prevent, e.g., tooth jumping, or they feature other functional disadvantages. In addition, these are cost intensive in production and complicated in handling.

### SUMMARY

The invention is based on the objective of creating a traction mechanism drive for machine parts and drive assemblies with which preliminary tensioning losses of the traction or belt mechanism can be prevented and that can be produced economically.

The invention is based on the knowledge that the appearance of preliminary tensioning losses in the traction mechanism drive, for example, the standstill of an engine or another drive assembly, can result in functional disruptions for the control of the traction mechanism drive.

For meeting the stated objective, the invention according to the features of the main claim starts from a traction mechanism drive for machine parts and drive assemblies, for example, in automotive engineering, with an endless belt element, wherein the belt element is guided via driving and driven wheels and with a tensioning rail that can rotate about a point of rotation on one end for contacting the belt element, and also with an actuator acting on the tensioning rail. In addition, in this traction mechanism drive it is provided that a mechanical free-wheel is integrated at the point of rotation of the tensioning rail at one end as a reverse-rotation locking or limiting device.

Through this configuration it is advantageously achieved that, instead of a catch or latch system in the chain tensioning part of the traction mechanism drive, a reverse-rotation locking or limiting device is used in the tensioning rail that is constructed as a free-wheel at a point of rotation of the tensioning rail at one end. Such a reverse-rotation locking or limiting device is applied in such a way that it allows slight unimpaired reverse-rotation movement of the tensioning rail due to dynamic movements in the operation of the traction mechanism drive and heat expansion. Therefore, significant losses in preliminary tensioning in the traction mechanism drive are avoided during its standstill.

Furthermore, the function of the proposed free-wheel is purely mechanical, so that a loss of function of the traction mechanism drive due to a lack of oil-supply pressure, for example, at a standstill of the driving engine, can be excluded, but all other functions of the tensioning element are maintained.

As an advantageous functional feature, according to another configuration of the traction mechanism drive according to the invention, it can also be provided that the free-wheel integrated into the point of rotation of the tensioning rail at one end can rotate freely in the reverse direction by an angular magnitude of 1° to 10°, and more advantageously 1° to 4°.

According to another configuration of the solution according to the invention, the tensioning rail has, at the point of rotation at one end, a rotationally locked bearing pin that is mounted on a base, advantageously an engine or a cylinder head. The rotationally locked bearing pin allows the slight reverse-rotation movement of 1° to 10°, preferably approximately 1° to 4° at the point of rotation of the tensioning rail at one end.

The actuator that acts on the tensioning rail is provided for tensioning the belt or traction element. This actuator can be constructed as a hydraulic piston-cylinder unit or spring-damper element.

### BRIEF DESCRIPTION OF THE DRAWINGS

The invention will be explained in more detail below with reference to the accompanying drawing using one embodiment. Shown therein are

FIG. 1 is a schematic diagram of a traction mechanism drive according to the invention.

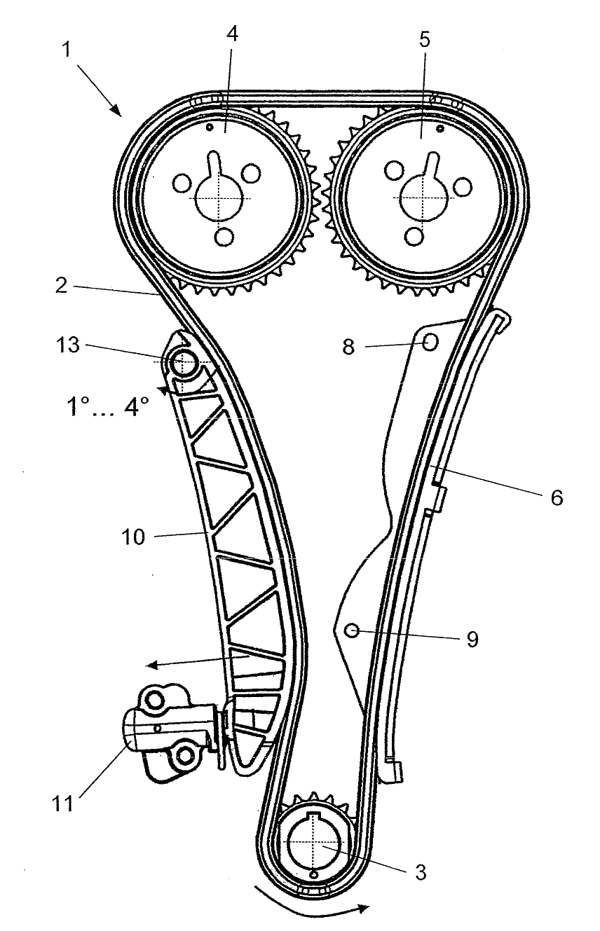

### DETAILED DESCRIPTION OF THE DRAWING

The traction mechanism drive 1 shown in the FIGURE on an internal combustion engine not shown in more detail has belt of traction element 2 constructed as an endless chain. This traction element loops around a driving wheel 3 of a crankshaft of the internal combustion engine and also two driven wheels 4 and 5 of two camshafts that are spaced apart from each other.

In addition, the traction element 2 is guided by a rail-like sliding element 6 that is mounted and supported on a base 7, e.g., an engine block, at the points 8 and 9. In addition, the traction element 2 is guided by a tensioning rail 10, wherein the latter is supported with its upper end so that it can pivot at a point of rotation 13 on the base 7 and acts as a tensioning device for the traction element 2. On the bottom end of the tensioning rail 10, an actuator 11 constructed as a hydraulic piston-cylinder unit and controllable by a not-shown control unit acts with a contact pressure force.

The upper end of the tensioning rail 10 is mounted with a bearing pin 12 in a rotationally locked way on the base 7, wherein at the point of rotation 13 of the tensioning rail 10, a mechanical free-wheel is integrated that acts as a reverse-rotation locking or limiting device for the tensioning rail 10. The free-wheel is constructed so that it can rotate freely in the reverse direction by an angular magnitude of approximately 1° to 10°, advantageously of 1° to 4°.

In the case of the reverse rotation of the driving wheel 3 of the crankshaft of the internal combustion engine in the direction of the arrow on this part, for example, when the engine is turned off or for a vehicle stopped on a hill with an engaged gear, the loose section of the traction element 2 is tensioned. Here, the tensioning rail 10 is pressed together and the actuator 11 is compressed. In this state, the traction element 2 can jump and can result in damage to the internal combustion engine. For known traction mechanism drives, this is prevented at least partially with tensioning elements with an integrated drop locking device, such as catch or latch devices. For this solution according to the invention, instead of a catch or latch system, a mechanical free-wheel is used as a reverse-rotation locking or limiting device at the point of rotation 13 of the tensioning rail 10.

### LIST OF REFERENCE SYMBOLS

1 Traction mechanism drive
2 Traction element
3 Driving wheel of crankshaft
4 Driven wheel of camshaft
5 Driven wheel of camshaft
6 Sliding element
7 Base
8 Mounting point
9 Mounting point
10 Tensioning rail
11 Actuator
12 Bearing pin
13 Point of rotation, free-wheel

1. Traction mechanism drive for machine parts and drive assemblies, comprising an endless traction element that is guided by driving and driven wheels and with a tensioning rail that can rotate about a point of rotation on one end for contacting the traction element and also an actuator acting on the tensioning rail, and a mechanical free-wheel is integrated at the point of rotation of the tensioning rail at the one end as a reverse-rotation locking or limiting device.

2. Traction mechanism drive according to claim 1, wherein the mechanical free-wheel integrated at the point of rotation of the tensioning rail at the one end can rotate freely in a reverse direction by an angular magnitude of 1° to 10°.

3. Traction mechanism drive according to claim 1, wherein at the point of rotation at the one end, the tensioning rail has a bearing pin that is locked in rotation and that is mounted to a base.

4. Traction mechanism drive according to claim 1, wherein the actuator acting on the tensioning rail comprises a hydraulic piston-cylinder unit or spring-damper element.
